(19) United States
(12) Patent Application Publication
(10) Pub. No.: US 2019/0129346 A1
(43) Pub. Date: May 2, 2019

(54) IMAGE FORMER AND CONVEYANCE CONTROL METHOD

(71) Applicant: Konica Minolta, Inc., Tokyo (JP)

(72) Inventors: Takahiro OKUBO, Yokohama-shi (JP); Yasuo SHIOKAWA, Tokyo (JP); Yoshiteru KAWAKAMI, Tokyo (JP)

(21) Appl. No.: 16/171,963

(22) Filed: Oct. 26, 2018

(30) Foreign Application Priority Data
Oct. 30, 2017 (JP) 2017-209219

(51) Int. Cl. G03G 15/00; G03G 15/16

(52) U.S. Cl. CPC G03G 15/6561; G03G 15/1605

(57) ABSTRACT

An image former includes: a transferer that transfers an image onto a sheet; a registration roller provided on an upstream side of the transferer in a sheet conveyance direction; and a hardware processor that controls operation of the registration roller, wherein the hardware processor controls operation of the registration roller so as to execute either one of first operation of abutting a leading edge of the sheet in the conveyance direction against the registration roller and second operation of not abutting the leading edge of the sheet against the registration roller.

### CROSS REFERENCE TO RELATED APPLICATION

The present application claims priority under 35 U.S.C. § 119 to Japanese patent Application No. 2017-209219, filed on Oct. 30, 2017, the disclosure of which is incorporated herein by reference.

### BACKGROUND

### Technological Field

The present invention relates to an image former and a conveyance control method.

### Description of the Related Art

Generally, an image former (printer, copier, facsimile, etc.) utilizing an electrophotographic process technology forms an electrostatic latent image based on image data by emitting laser light (exposure) toward a charged photoconductive drum (image carrier). The image former feeds toner from a developing unit to the photoconductive drum on which the electrostatic latent image is formed to visualize the electrostatic latent image so as to form a toner image. Furthermore, the image former primarily or secondarily transfers the toner image onto a sheet, heats and pressurizes the sheet at a fixing nip of a fixing unit to fix the toner image on the sheet. Furthermore, the image former includes a registration roller provided on an upstream side of a transferer that transfers an image to the sheet. The registration roller has a function of rotating to adjust the conveyance speed of the sheet so as to feed the sheet to the transferer in order to align a leading edge side in the sheet conveyance direction with the leading edge of the image.

Furthermore, a conventional registration roller has a function of correcting skew (hereinafter referred to as skew correction) on the leading edge side in the sheet conveyance direction using a technique of abutting the conveyed sheet. Furthermore, a certain registration roller has a function (hereinafter referred to as misalignment correction) of correcting misalignment in a width direction of the sheet by swinging along the width direction of the sheet after performing this skew correction (refer to JP 2014-133634 A, for example).

Meanwhile, an image former typically uses flat rectangular sheets (such as regular sheets such as A4) most frequently as a transfer sheet (recording material) for printing, while there is a case of using sheets with various shapes, such as an envelope, an ultra-thin or ultra-thick sheet material and a sheet with rough cutting and not having a right-angled edge portion. Furthermore, potential demands for printing images on sheet of various planar shapes other than rectangles are also considered to be high.

In formation of an image on a sheet having different shapes, thicknesses, or the like on the leading edge side and the trailing edge side in the conveyance direction, such as on an envelope having a flap, however, it has been difficult with the operation of the conventional registration roller to ensure accuracy of a position of an image to be formed (that is, achieve image assurance).

Furthermore, in a case where double-sided printing is performed on a special sheet such as the envelope on an image former that performs double-sided printing using sheet switchback conveyance, the shape and the thickness of the leading edge of the sheet that enters the registration roller differs between the printing of the first surface and the printing of the second surface. Therefore, in such a case, it has been difficult to achieve image assurance on both front and back sides of the sheet through a series of operation in double-sided printing.

### SUMMARY

An object of the present invention is to provide an image former and a conveyance control method capable of improving the positional accuracy of a transferred image with a variety of sheets.

To achieve the abovementioned object, according to an aspect of the present invention, an image former reflecting one aspect of the present invention comprises:

a transferer that transfers an image onto a sheet;

a registration roller provided on an upstream side of the transferer in a sheet conveyance direction; and

a hardware processor that controls operation of the registration roller,

wherein the hardware processor controls operation of the registration roller so as to execute either one of first operation of abutting a leading edge of the sheet in the conveyance direction against the registration roller and second operation of not abutting the leading edge of the sheet against the registration roller.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating a whole configuration of an image former according to the present embodiment;

FIG. 2 is a diagram illustrating a main portion of a control system of the image former according to the present embodiment;

FIG. 3A and FIG. 3B are plan views illustrating operation of a conventional registration roller pair, in which FIG. 3A illustrates a state before the lower side of an envelope is abutted against the registration roller pair, and FIG. 3B illustrates a state before the upper side (flap side) of the envelope is abutted against the registration roller pair;

FIG. 4 is a plan view illustrating second operation of the registration roller pair in the present embodiment, illustrating a state where registration swing control is performed after conveyance without abutment of the upper side (flap side) of the envelope;

FIG. 5A and FIG. 5B are plan views illustrating operation of a conventional registration roller pair, in which FIG. 5A illustrates a state when the lower side of the envelope is abutted against the registration roller pair, and FIG. 5B illustrates a state where skew of the lower side of the envelope has been corrected;

FIG. 6A and FIG. 6B are plan views illustrating the second operation of the registration roller pair in the present embodiment in comparison with FIG. 5A and FIG. 5B, in which FIG. 6A illustrates a state where the lower edge side of the envelope is fed through the registration roller pair, and FIG. 6B illustrates a state after the lower edge side of the envelope is fed without being abutted against the registration roller pair; and

FIG. 7 is a flowchart illustrating an example of controlling operation of the registration roller pair in the present embodiment.

### DETAILED DESCRIPTION OF EMBODIMENTS

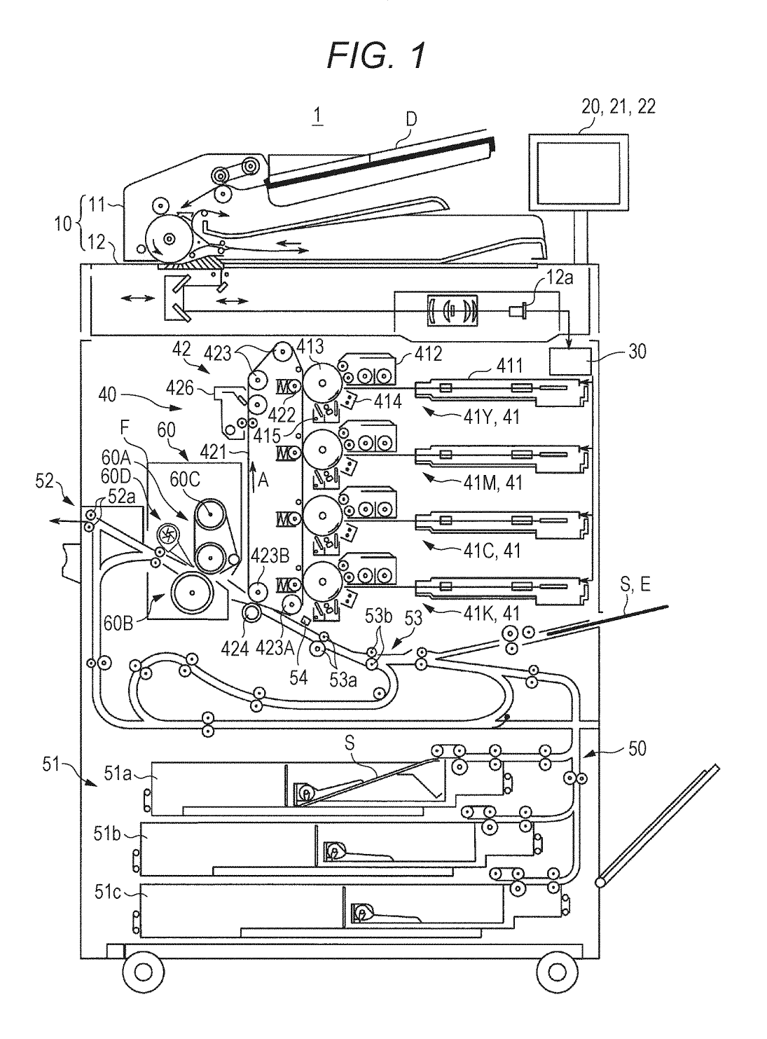

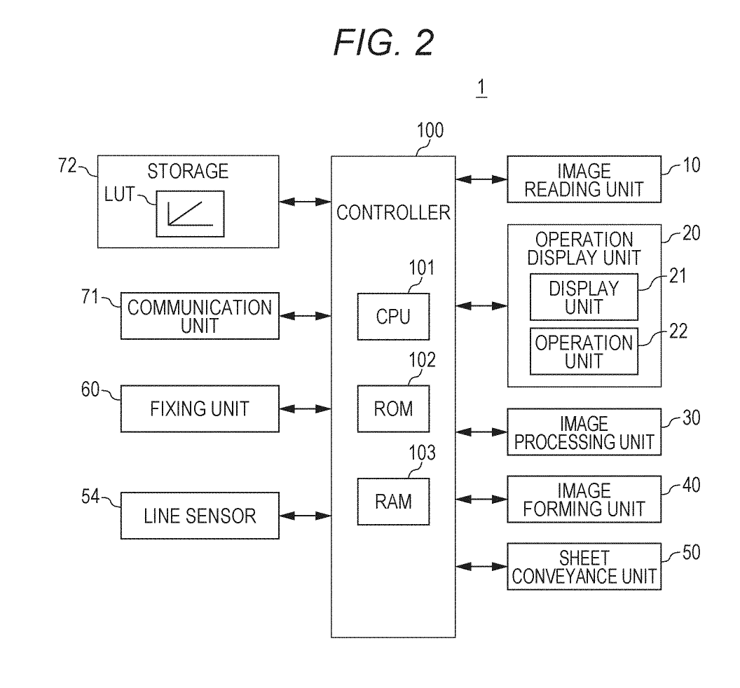

Hereinafter, one or more embodiments of the present invention will be described in detail with reference to the drawings. However, the scope of the invention is not limited to the disclosed embodiments. FIG. 1 is a diagram schematically illustrating a whole configuration of an image former 1 according to the present embodiment. FIG. 2 is a diagram illustrating a main portion of a control system of the image former 1 according to the present embodiment.

The image former 1 of the present embodiment forms an image on a sheet S including regular sheets (standard sheets) such as generally used A4 and A3 sheets, and a variety of other special sheets.

In the present embodiment, the special sheet includes a variety of modes, for example, an envelope, long sheets or roll sheets longer in the conveyance direction than the standard sheet, ultra-thin or ultra-thick sheets, label sheets, sheets having rough cutting and having not-right-angled edge portion, trapezoidal or parallelogramic sheets, triangular or polygonal sheets with five or more corners, sheet with curved sides, sheets formed of materials other than paper (for example, resin).

Hereinafter, a simple description of “sheet S” will include both the regular sheet (standard sheet) and the special sheet described above. Now, as an example of using a special sheet, a case where an image is formed on an envelope E (refer to FIG. 4 or the like) will be described below.

The image former 1 is an intermediate transfer system color image former utilizing an electrophotographic process technology. Specifically, the image former 1 performs primary transfer of toner images of each of colors of yellow (Y), magenta (M), cyan (C), and black (K) formed on a photoconductive drum 413 to an intermediate transfer belt 421, and then, the toner images of the four colors are overlapped with each other on the intermediate transfer belt 421, and then, the toner image secondary-transferred onto a sheet S so as to form an image.

The image former 1 adopts a tandem system in which the photoconductive drums 413 corresponding to the four colors of Y, M, C, and K are arranged in series in a running direction of the intermediate transfer belt 421, and the toner images of individual colors are sequentially transferred onto the intermediate transfer belt 421 in a single procedure.

As illustrated in FIG. 2, the image former 1 includes an image reading unit 10, an operation display unit 20, an image processing unit 30, an image forming unit 40, a sheet conveyance unit 50, a fixing unit 60, and a controller 100.

The controller 100 includes a central processing unit (CPU) 101, a read only memory (ROM) 102, and a random access memory (RAM) 103. The CPU 101 reads a program corresponding to processing content from the ROM 102, develops the program in the RAM 103, and centrally controls operation of each of blocks of the image former 1 in cooperation with the developed program. At this time, a variety of data stored in the storage 72 is referenced. The storage 72 includes, for example, a nonvolatile semiconductor memory (or flash memory) and a hard disk drive.

The controller 100 transmits/receives a variety of data to/from an external apparatus (for example, a personal computer) connected to a communication network such as a local area network (LAN), a wide area network (WAN) via a communication unit 71. For example, the controller 100 receives image data transmitted from an external apparatus and controls to form a toner image on the sheet S on the basis of the image data (input image data). The communication unit 71 includes a communication control card such as a LAN card.

The image reading unit 10 includes an automatic document feeder (ADF) 11, and a document image scanner (scanner) 12.

The automatic document feeder 11 conveys a document D mounted in a document tray by a conveyance mechanism and feeds the document to the document image scanner 12. The automatic document feeder 11 can collectively and consecutively read images (including double-sided image) on a large number of documents D mounted in the document tray.

The document image scanner 12 optically scans a document conveyed onto a contact glass portion from the automatic document feeder 11 or a document placed on the contact glass portion, and focuses reflected light from the document on a light receiving plane of a charge coupled device (CCD) sensor 12a to read a document image. The image reading unit 10 generates input image data on the basis of a reading result obtained by the document image scanner 12. The input image data undergoes predetermined image processing in the image processing unit 30.

The operation display unit 20 includes a liquid crystal display (LCD) having a touch screen, for example, and functions as a display unit 21 and an operation unit 22. According to a display control signal input from the controller 100, the display unit 21 displays various operation screens, states of images, individual function operation status, or the like. The operation unit 22 includes various operation keys such as a numeric keypad, and a start key, receives a variety of input operation from a user, and outputs an operation signal to the controller 100.

The image processing unit 30 includes a circuit for performing digital image processing corresponding to initial setting or user setting, on the input image data. For example, the image processing unit 30 performs tone correction on the basis of tone correction data (tone correction table LUT) in the storage 72 under the control of the controller 100. In addition to the tone correction, the image processing unit 30 applies a variety of correction processing such as color correction, shading correction, compression processing, on the input image data. The image forming unit 40 is controlled on the basis of the processed image data.

The image forming unit 40 includes image forming units 41Y, 41M, 41C, and 41K for forming images with color toners of a Y component, a M component, a C component, and a K component, on the basis of the input image data, and includes an intermediate transfer unit 42.

The image forming units 41Y, 41M, 41C, and 41K for the Y component, the M component, the C component, and the K component have a similar configuration. For the convenience of illustration and explanation, components by which same explanation can be shared are denoted by a same reference sign, and Y, M, C, or K is added to the reference sign in a case where there is a need to distinguish between them. In FIG. 1, reference signs are representatively provided to the components of the image forming unit 41Y for the Y component and the reference signs of the components of the other image forming units 41M, 41C, 41K are omitted.

The image forming unit 41 includes an exposure apparatus 411, a developing apparatus 412, a photoconductive drum 413, a charging apparatus 414, a drum cleaning apparatus 415.

The photoconductive drum 413 is a negative charge type organic photoconductor (OPC) formed, for example, with an under coat layer (UCL), a charge generation layer (CGL), a charge transport layer (CTL), sequentially laminated on a peripheral surface of an aluminum conductive cylindrical body (aluminum pipe). The charge generation layer is formed of an organic semiconductor in which a charge generation material (for example, a phthalocyanine pigment) is dispersed in a resin binder (for example, polycarbonate), and generates a pair of positive charge and negative charge at exposure performed by the exposure apparatus 411. The charge transport layer is formed by dispersing a hole transporting material (electron-donating nitrogen-containing compound) in a resin binder (for example, polycarbonate resin), and transports positive charges generated in the charge generation layer to the surface of the charge transport layer.

The controller 100 controls a driving current supplied to a driving motor (not illustrated) that rotates the photoconductive drum 413 so as to rotate the photoconductive drum 413 at a constant peripheral velocity (linear velocity).

The charging apparatus 414 uniformly negatively charges the surface of the photoconductive drum 413 having photoconductivity. The exposure apparatus 411 includes a semiconductor laser, for example, and emits laser light corresponding to images of individual color components toward the photoconductive drum 413. An electrostatic latent image of each of the color components is formed on the surface of the photoconductive drum 413 due to a potential difference with the surroundings.

The developing apparatus 412 is a two-component develop type developing apparatus and forms a toner image by visualizing the electrostatic latent image by adhering toner of each of the color components to the surface of the photoconductive drum 413.

The drum cleaning apparatus 415 includes a cleaning blade or the like to be in sliding contact with the surface of the photoconductive drum 413. The drum cleaning apparatus 415 uses the cleaning blade to remove the transfer residual toner remaining on the surface of the photoconductive drum 413 after the primary transfer.

The intermediate transfer unit 42 includes an intermediate transfer belt 421, a primary transfer roller 422, a plurality of support rollers 423, a secondary transfer roller 424, and a belt cleaning apparatus 426.

The intermediate transfer belt 421 is formed with an endless belt and stretched in a loop around the plurality of support rollers 423. At least one of the plurality of support rollers 423 is constituted with a driving roller, and the other is (are) constituted by a driven roller. For example, it is preferable that a driving roller be used as a roller 423A disposed more toward the downstream side than the primary transfer roller 422 for the K component in the belt running direction. This facilitates holding the running speed of the belt at a constant level at a primary transferer. The rotation of the driving roller 423A allows the intermediate transfer belt 421 to run in an arrow direction A at a constant speed.

The primary transfer roller 422 is arranged on an inner peripheral surface side of the intermediate transfer belt 421 so as to face the photoconductive drum 413 of each of the color components. The primary transfer roller 422 comes in pressing contact with the photoconductive drum 413 having the intermediate transfer belt 421 in between, so as to form a primary transfer nip for transferring a toner image from the photoconductive drum 413 to the intermediate transfer belt 421.

The secondary transfer roller 424 is arranged on the outer peripheral surface side of the intermediate transfer belt 421 so as to face a backup roller 423B arranged on a downstream side in a belt running direction of the driving roller 423A. The secondary transfer roller 424 comes in pressing contact with the backup roller 423B having the intermediate transfer belt 421 in between, so as to form a secondary transfer nip for transferring a toner image from the intermediate transfer belt 421 to the sheet S.

The secondary transfer nip formed by the intermediate transfer belt 421, the backup roller 423B, and the secondary transfer roller 424 corresponds to the “transferer” of the present invention.

When the intermediate transfer belt 421 passes through the primary transfer nip, toner images on the photoconductive drum 413 are overlapped and primary transferred sequentially onto the intermediate transfer belt 421. Specifically, a primary transfer bias is applied to the primary transfer roller 422, and a charge having a polarity opposite to the polarity of the toner is applied to the side of the intermediate transfer belt 421, that is, the side coming in contact with the primary transfer roller 422, whereby the toner image is electrostatically transferred to the intermediate transfer belt 421.

Thereafter, when the sheet S passes through the secondary transfer nip, the toner image on the intermediate transfer belt 421 is secondary-transferred onto the sheet. More specifically, a secondary transfer bias is applied to the secondary transfer roller 424, and a charge having a polarity opposite to the polarity of the toner is applied to the side of the sheet S coming in contact with the secondary transfer roller 424, whereby the toner image is electrostatically transferred to the sheet. The sheet S on which the toner image has been transferred is conveyed toward the fixing unit 60.

The belt cleaning apparatus 426 includes a belt cleaning blade or the like that comes in sliding contact with the surface of the intermediate transfer belt 421, and removes transfer residual toner remaining on the surface of the intermediate transfer belt 421 after the secondary transfer.

The fixing unit 60 includes: an upper fixing unit 60A including a fixing surface-side member arranged on a fixing surface side of the sheet S; a lower fixing unit 60B including a back side support member arranged on a side opposite to the fixing surface of the sheet S; and a heat source 60C. The back side support member comes in pressing contact with the fixing surface-side member, so as to form a fixing nip for holding and conveying the sheet S.

The fixing unit 60 allows the conveyed sheet S on which the toner image is secondary-transferred to be heated and pressurized at the fixing nip so as to fix the toner image onto the sheet S. The fixing unit 60 is disposed as a unit in a fixing device F. Furthermore, the fixing device F includes an air separation unit 60D provided to blow air to separate the sheet S from the fixing surface-side member.

The sheet conveyance unit 50 includes a sheet feeder 51, a sheet discharge unit 52, and a conveyance path unit 53. Three sheet feeding tray units M a to 51c constituting the sheet feeder 51 contains the sheet S (standard sheets and special sheets) identified on the basis of the grammage (rigidity) and size, being classified into each of preset types. The conveyance path unit 53 includes: a plurality of conveyance rollers such as a registration roller pair 53a and a loop roller 53b; a double-side conveyance path for forming images on both sides of the sheet; and an external sheet feed conveyance path for feeding the sheet S from the outside (right side in FIG. 1) of the apparatus. The registration roller pair 53a corresponds to the “registration roller” of the present invention.

Under the control of the controller 100, the registration roller pair 53a plays a role of performing skew correction of the sheet S and a role of correcting misalignment of the sheet S. Furthermore, under the control of the controller 100, the registration roller pair 53a has a function of rotating so as to achieve alignment to the position of the toner image secondarily transferred onto the sheet S, in the sheet conveyance direction, to adjust the conveyance speed of the sheet S.

Here, the sheet skew correction is to correct the sheet skew on the leading edge side in the sheet conveyance direction by abutting the conveyed sheet S against the registration roller pair 53a. In the present embodiment, the controller 100 outputs a control signal to a driving source (such as a motor) of the registration roller pair 53a at sheet skew correction so as to control the rotation of the registration roller pair 53a. Details of control of sheet skew correction will be described below.

On the other hand, the misalignment correction of the sheet S is to correct the position in the width direction of the sheet S by swinging of the registration roller pair 53a. That is, the sheet S is nipped by the nip of the registration roller pair 53a (hereinafter referred to as registration nip), and thereafter, the control of the swing operation (registration swing) in which the registration roller pair 53a moves in the width direction to move the sheet S is performed to correct the position of the sheet S in the width direction. In the present embodiment, a motor (stepping motor or the like) different from the motor for rotating the registration roller pair 53a is used as a driving source for swinging the registration roller pair 53a. Details of the control of registration swing will be described below.

The loop roller 53b is a roller pair arranged on the upstream side of the registration roller pair 53a in the conveyance direction. Under the control of the controller 100, the loop roller 53b rotates to form a loop on the sheet S with the registration roller pair 53a, so as to correct the skew of the sheet S in cooperation with the registration roller pair 53a.

A line sensor 54 is disposed upstream side of the secondary transfer nip, on the downstream side of the registration roller pair 53a in the sheet conveyance direction. The line sensor 54 is a sensor having photoelectric conversion elements arranged in a line shape and detects one edge portion in the width direction of the sheet S (hereinafter referred to as a side edge), and senses deviation of the sheet S (misalignment from a reference or a target position).

The sheets S contained in the sheet feeding tray units 51a to 51c are fed one by one from an uppermost portion and are conveyed to the image forming unit 40 by the conveyance path unit 53. Alternatively, the sheet S is conveyed from the external sheet feed tray (not illustrated) or the sheet feeder (not illustrated) connected to the image former 1 to the image forming unit 40 via the above-described external sheet feed conveyance path. At this time, a side of the leading edge of the fed sheet S in the conveyance direction is abutted against the registration roller pair 53a to set the side of the leading edge to be parallel to the axis of the registration roller pair 53a, so as to correct (skew correction) skew of the sheet S and adjust the conveyance timing of the sheet S.

Subsequently, the toner image of the intermediate transfer belt 421 is collectively secondary-transferred onto one surface of the sheet S on the image forming unit 40, and then, undergoes a fixing step on the fixing unit 60. The sheet S on which an image has been formed is discharged to the outside of the apparatus by the sheet discharge unit 52 having a sheet discharge roller 52a. In double-sided printing, the sheet S on which an image has been formed on the first side is switchback conveyed via the double-side conveyance path to reverse the leading and trailing edges in the conveyance direction. After reversal of the leading and trailing edges, the toner image is secondarily transferred and fixed on the second side, and the sheet S is discharged to the outside of the apparatus by the sheet discharge unit 52.

Meanwhile, an image former typically uses flat rectangular sheets (such as regular sheets such as A4) most frequently as a transfer sheet (recording material) for printing, while there is a case of using sheets with various shapes, such as an envelope, an ultra-thin or ultra-thick sheet and a sheet with rough cutting and not having a right-angled edge portion. Furthermore, potential demands for printing images on a special sheet of various planar shapes other than rectangles are also considered to be high.

However, in the case of forming an image on the sheet S having different shapes, thicknesses, or the like on the leading edge side and the trailing edge side in the conveyance direction, such as on an envelope having a flap, it is difficult with the operation of the conventional registration roller pair 53a to ensure accuracy of a position of an image to be formed (that is, achieve image assurance).

Furthermore, in a case where double-sided printing is performed on an envelope on an image former 1 that performs double-sided printing using sheet switchback conveyance as in the present embodiment, the shape and the thickness in the conveyance direction of the leading edge of the envelope that enters the registration roller pair 53a differs in the printing of the first surface and the printing of the second surface. Therefore, in such a case, it has been difficult to achieve image assurance on both sides of sheet S by a series of operation in double-sided printing.

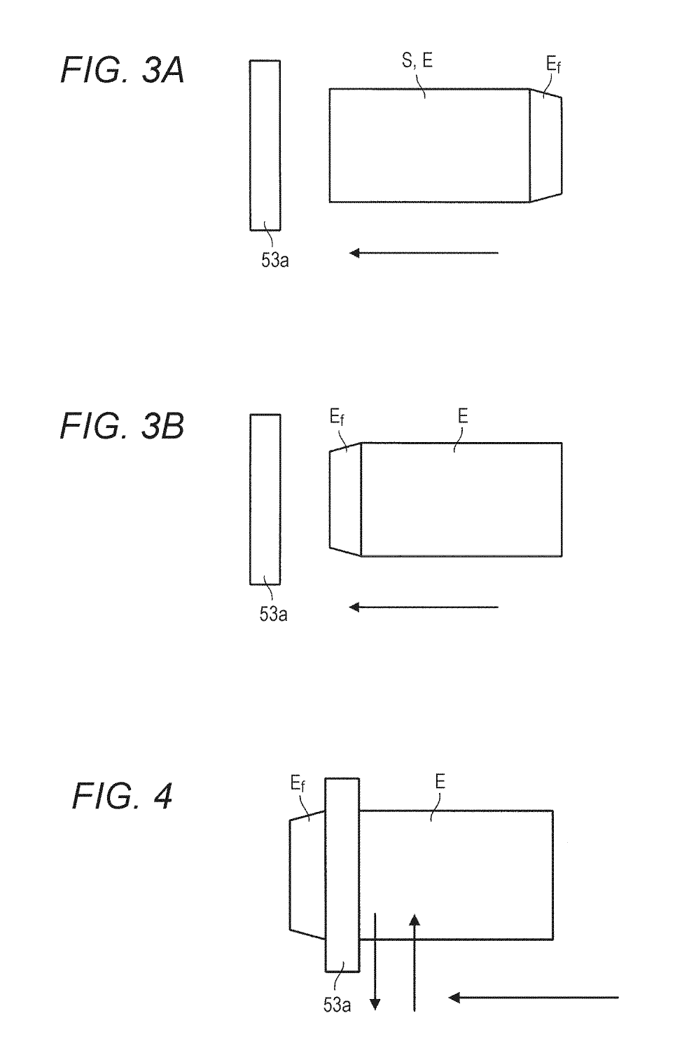

The above problem will be more specifically described with reference to FIG. 3A and FIG. 3B. Here, FIG. 3A illustrates a state before a lower side of an envelope E is abutted against the registration roller pair 53a, while FIG. 3B illustrates a state before an upper side of the envelope E is abutted against the registration roller pair 53a. Arrows illustrated along the length direction of the envelope E in FIG. 3A and FIG. 3B indicate the conveyance direction of the envelope E. For simplicity, illustration of the loop roller 53b is omitted in FIG. 3A and FIG. 3B, and the same applies to FIG. 4 to FIG. 6B to be described below.

As illustrated in FIG. 3A, in a case where the leading edge in the conveyance direction is on the lower side of the envelope E, it is possible to normally perform skew correction of the envelope E by the similar registration operation (normal registration operation) as in the conventional technique. Here, the normal registration operation is performed with rotation of the registration roller pair 53a as follows under the control of the controller 100. That is, the registration roller pair 53a stops rotating (or rotating in the reverse feeding direction) until abutment of the lower side (bottom side) of the envelope E. When the bottom side of the envelope E abuts against the registration roller pair 53a, the registration roller pair 53a starts to rotate in the forward feeding direction (that is, the conveyance direction to the secondary transfer nip).

More specifically, the upstream side of the envelope E is conveyed by the loop roller 53b, and when the bottom side of the envelope E abuts against the registration roller pair 53a (in a state of rotation stop or the like), the rotation of the loop roller 53b forms a loop (sheet deflection). At this time, the entire bottom side of the envelope E equally comes in contact with the nip of the registration roller pair 53a, correcting the skew of the envelope E. Thereafter, when the registration roller pair 53a starts forward feeding rotation, the envelope E is conveyed toward the secondary transfer nip in a state in which the skew has been corrected.

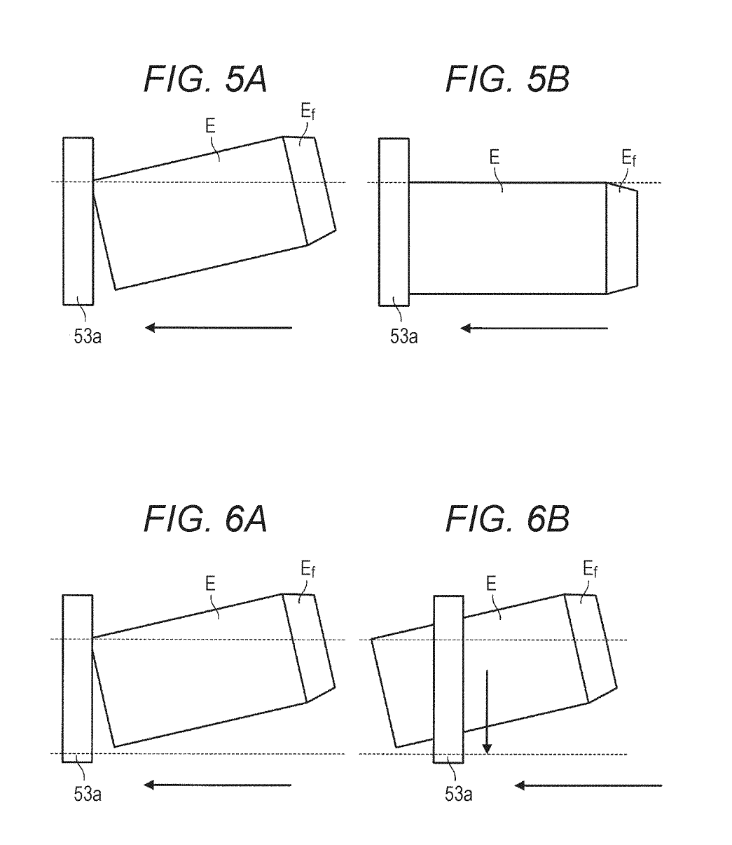

In the normal registration operation, the rotation of the registration roller pair 53a is switched in this manner, so that the envelope E undergoes skew correction using the registration roller pair 53a (refer to FIG. 5A and FIG. 5B) and is conveyed toward the secondary transfer nip.

In contrast, as illustrated in FIG. 3B, in a case where the leading edge in the conveyance direction is on the upper side of the envelope E (side having a flap E_{f}, the same applies hereinafter), the skew correction of the envelope E might not be performed normally with the above-described ordinary registration operation. Specifically, the flap E_{f} of the envelope E is a thinner and more unstable site as compared with the main body portion of the envelope E. In addition, the upper side of the flap E_{f} is likely to deform and might not be parallel to the bottom side of the envelope E (that is, not orthogonal to the sides of the envelope E).

For this reason, in the case where the leading edge in the conveyance direction corresponds to the upper side of the envelope E, executing normal registration operation might not be successful in normal skew correction, for example, might deteriorate the skew (skewed state) of the envelope E. In this case, there is a concern that the skew of the envelope E might not be completely corrected in the swing operation of the registration roller pair 53a (that is, the control of registration swing) after the registration operation, leading to difficulty in achieving the accuracy of the position of the image to be transferred at the secondary transfer nip (namely, image assurance).

Furthermore, in a case where double-sided printing of the envelope E is performed in the image former 1 that performs switchback conveyance of a sheet S for double-sided printing as in the present embodiment, the leading edge of the envelope E abutted against the registration roller pair 53a is on the opposite side at printing on the first surface and the second surface, while there is no change in the side edges of the envelope E. Therefore, in execution of double-sided printing of the envelope E, the leading edge in the conveyance direction comes on the upper side (flap E_{f} side) of the envelope E during printing of either the first surface or the second surface. Therefore, in a case where registration operation similar to the conventional one is performed, it is difficult to achieve image assurance on both the front and back surfaces of the envelope E during double-sided printing of the envelope E.

Therefore, the image former 1 of the present embodiment has a configuration in which operation not abutting the leading edge of the sheet S in the conveyance direction against the registration roller pair 53a is selectable as the sheet conveyance operation of the registration roller pair 53a. Specifically, the controller 100 controls operation of the registration roller pair 53a to perform one of registration operation (first operation) of abutting the leading edge of the sheet S in the conveyance direction against the registration roller pair 53a and registrationless operation (second operation) of not abutting the leading edge of the sheet S against the registration roller pair 53a.

In the present embodiment, the first operation is the same as the above-described conventional (normal) registration operation. In contrast, the registrationless operation (second operation) in the present embodiment is operation of rotating the registration roller pair 53a in the conveyance direction (forward feeding direction) before the leading edge of the sheet S reaches (enters) the registration roller pair 53a. That is, in execution of the registrationless operation (second operation), the controller 100 outputs a control signal to the motor that performs rotation driving of the registration roller pair 53a so as to rotate the registration roller pair 53a in the conveyance direction before the leading edge of the sheet S enters the registration roller pair 53a.

In this example, the rotation speed of the registration roller pair 53a is controlled to be substantially the same as the rotation speed of the loop roller 53b at the start of execution of the registrationless operation (second operation) from the viewpoint of improving the productivity. Therefore, at the time of executing the second operation, a loop of sheet is not formed between the loop roller 53b and the registration roller pair 53a. Note that the rotation speed of the registration roller pair 53a at the start of execution of the registrationless operation (second operation) can be adjusted to any speed through a user setting screen or the like (not illustrated).

Since the sheet skew correction using the registration roller pair 53a is not performed at execution of this registrationless operation, it is possible to prevent a situation of deteriorating the sheet skew (skewed state) as described above. On the other hand, since the skew of the sheet S is not corrected in the registrationless operation, the present embodiment swings the registration roller pair 53a to correct the skew of the sheet S after execution of the registrationless operation, as illustrated in FIG. 4. In FIG. 4, the swing direction of the registration roller pair 53a is indicated by two arrows.

The swing operation of the registration roller pair 53a is also performed after execution of the first operation (that is, the normal registration operation). That is, the controller 100 controls swing of the registration roller pair 53a to swing the sheet S along the sheet width direction after execution of the registration operation (first operation) or the registrationless operation (second operation).

In addition, the controller 100 performs control of adjusting the rotation speed of the registration roller pair 53a (that is, sheet conveyance speed) so as to match the leading edge side of the sheet S to the position in the sheet conveyance direction where the toner image is transferred by the secondary transfer nip (transferer) after execution of the registration operation (first operation) or the registrationless operation (second operation). This control is referred to as “leading edge timing adjustment”, and it is adapted to accelerate or decelerate the sheet conveyance speed using a known method to finally adjust the speed to the conveyance speed at the secondary transfer nip, and this control is executed in parallel with the swing operation of the registration roller pair 53a.

In the present embodiment, the control of the leading edge timing adjustment after execution of the registrationless operation (second operation) is started at a predetermined timing after the entry of the leading edge of the sheet S into the registration roller pair 53a. For example, in a case where the sheet S is the envelope E, the control of the leading edge timing adjustment is started at a timing at which the flap E_{f} passes through the nip of the registration roller pair 53a (point at which the main body of the envelope E is nipped) as illustrated in FIG. 4. As another example, the control of leading edge timing adjustment after execution of the registrationless operation (second operation) is started at a timing when a portion of the sheet S is detected by the line sensor 54. As still another example, a dedicated sensor (not illustrated) for sensing the leading edge of the sheet S may be arranged separately from the line sensor 54 to start the control of the leading edge timing adjustment after execution of the registrationless operation (second operation) at a timing when the leading edge of the sheet S is sensed by this dedicated sensor.

In the present embodiment, the swing operation of the registration roller pair 53a after execution of the registrationless operation (second operation) has both aspects of sheet skew correction and sheet side edge misalignment correction (hereinafter, simply described as misalignment correction). In the present embodiment, this swing operation represents the operation of swinging the registration roller pair 53a a plurality of times or continuously sequentially moving the sheet S in the width direction (direction orthogonal to the conveyance direction) after execution of the registrationless operation (second operation) so that the side edge of the sheet S is always aligned with the target position. In addition, such swing operation, that is, swing control of the registration roller pair 53a performed by the controller 100 is continued (appropriately executed) even after the sheet S reaches the secondary transfer nip. Due to such swing operation of the registration roller pair 53a, it is possible to correct the skew and misalignment of the sheet S independent of shape of sheet leading edge side before the start of toner image transfer at the secondary transfer nip. As a result, it is possible to improve the positional accuracy of the transferred image with a variety of sheet S.

FIG. 4 illustrates the envelope E as an execution target of the second operation. This operation would be particularly effective in a case where the following in addition to the above is used as the execution target of the second operation: various other special sheets having shapes other than a straight line at the leading edge; a sheet S having a rough cutting state at the time of manufacture, and an ultra-thin sheet S having difficulty in sheet loop formation in cooperative operation of the registration roller pair 53a and the loop roller 53b.

In addition, the second operation can be effectively applied to long sheet having a size (length in the conveyance direction) that cannot be stored in the sheet feeding tray units 51a to 51c, and continuous sheet such as roll sheet. In this case, to cope with the long length in the sheet conveyance direction, execution of continuous swing operation of the registration roller pair 53a makes it possible to prevent skew of the sheet S over a period before and after the image transfer.

Note that as to which of the first operation and the second operation is to be executed as the operation at conveyance of the sheet S with the registration roller pair 53a may be determined by the controller 100 in accordance with image formation conditions (for example, sheet information indicating the type, size, etc. of the sheet S), or may be set by the user through the user setting screen.

FIGS. 5A and 5B and FIG. 6A and FIG. 6B illustrate exemplary movements of the envelope E in cases where the first operation is performed and the second operation is performed in a case where the leading edge in the conveyance direction is on the lower side of the envelope E.

FIG. 5A and FIG. 5B illustrate how the skew (skewed state) of the envelope E is corrected by the registration roller pair 53a in a case where the first operation, that is, the conventional registration operation is performed. Specifically, FIG. 5A illustrates a state before the correction and FIG. 5B illustrates a state after correction, and having a reference line parallel to the conveyance direction added in a dotted line. FIG. 6A and FIG. 6B illustrate the movement of the envelope E in a case where the second operation is performed. FIG. 6A corresponds to FIG. 5A, and FIG. 6B corresponds to FIG. 5B. FIG. 6A and FIG. 6B each illustrates an additional second reference line (dotted line) corresponding to the width of the envelope E in addition to the dotted line illustrated in each of FIG. 5A and FIG. 5B.

As illustrated in FIG. 5A and FIG. 5B, the conventional registration operation (first operation of the present embodiment) is implemented such that the leading edge of the sheet S in the conveyance direction (bottom side of the envelope E) abuts against the registration roller pair 53a and temporarily stops, leading to correction of the sheet S so as to allow the side edge of the sheet to be parallel or agree with the conveyance direction.

In contrast, the registration roller pair 53a has already rotated in the conveyance direction in the second operation of the present embodiment at a point illustrated in FIG. 6A. Accordingly, the leading edge of the sheet S (envelope E) is conveyed toward the secondary transfer nip without being abutted against (stopped temporarily) the registration roller pair 53a (refer to FIG. 6B). Therefore, the skew of the sheet S is not to be corrected at the point of the second operation. On the other hand, with execution of swing operation of the registration roller pair 53a in the width direction (in the left direction in this example) to the sheet S (envelope E) having skew as illustrated in FIG. 6B at the point of second operation, it is possible to perform correction to match the side edge of the sheet S (envelope E) with the conveyance direction before reaching the secondary transfer nip, and thus possible to correct the skew.

As described above, with correction on the secondary scanning side of the sheet S in the registrationless operation (second operation) of the present embodiment, it is possible to correct the skew regardless of the shape of the sheet S on the leading edge side in the conveyance direction.

Furthermore, as can be seen by comparing FIG. 5B with FIG. 6B, the registrationless operation (second operation) of the present embodiment omits operation of temporarily stopping the sheet S (envelope E) in abutment against the registration roller pair 53a, making it possible to reduce the conveyance time to the secondary transfer nip, leading to enhancement of productivity.

From the viewpoint of enhancement of productivity, it is also possible, in double-sided printing of special sheet such as envelope E, to set to execute registrationless operation (second operation) (not performing normal registration operation) for both the first surface and the second surface with user setting or the like. In execution of double-sided printing in the present embodiment using the switchback conveyance method, the side edge of the sheet S does not change between the first surface and the second surface, and thus, making this method advantageous in that it is possible to facilitate subsequent control of registration swing, etc. and apply shared operation in the case of executing registrationless operation both on the first surface and the second surface.

In order to achieve higher accuracy in the transferred toner image position in the swing operation of the registration roller pair 53a, on the other hand, the controller 100 can appropriately correct the target position of the side edge of the sheet S being conveyed (refer to dotted lines in FIG. 6A and FIG. 6B) to swing the registration roller pair 53a so that the side edge of the sheet S comes to the corrected target position.

Specifically, if the target position of the side edge of the sheet S is uniformly fixed at the time of swinging of the registration roller pair 53a, there is a possibility that a toner image formed at the secondary transfer nip might not be transferred to the correct position on the sheet S due to various factors (for example, distortion of the side edge shape of the sheet S, misalignment of the machine).

Therefore, in the swing control after executing the registration operation or the registrationless operation, the controller 100 appropriately corrects the target position of the side edge of the sheet S (that is, appropriately shifts the position of the dotted line in FIG. 6A and FIG. 6B) and swings the registration roller pair 53a so that the side edge of the sheet S comes to the corrected target position. With such control, it is possible to correct the skew and misalignment of the sheet S more correctly and to prevent occurrence of misalignment of the image.

In order to correct the above-mentioned target position, it is allowable, for example, to provide an image reading apparatus (scanner or the like) (not illustrated) at a subsequent stage of the image former 1 to perform test printing of the sheet S on the image former 1 beforehand. Then, the position of the image on the test-printed sheet S is scanned by the image reading apparatus to detect the degree of misalignment of the image, and this detection result is fed back to a correction value of the target position on the side edge of the sheet S.

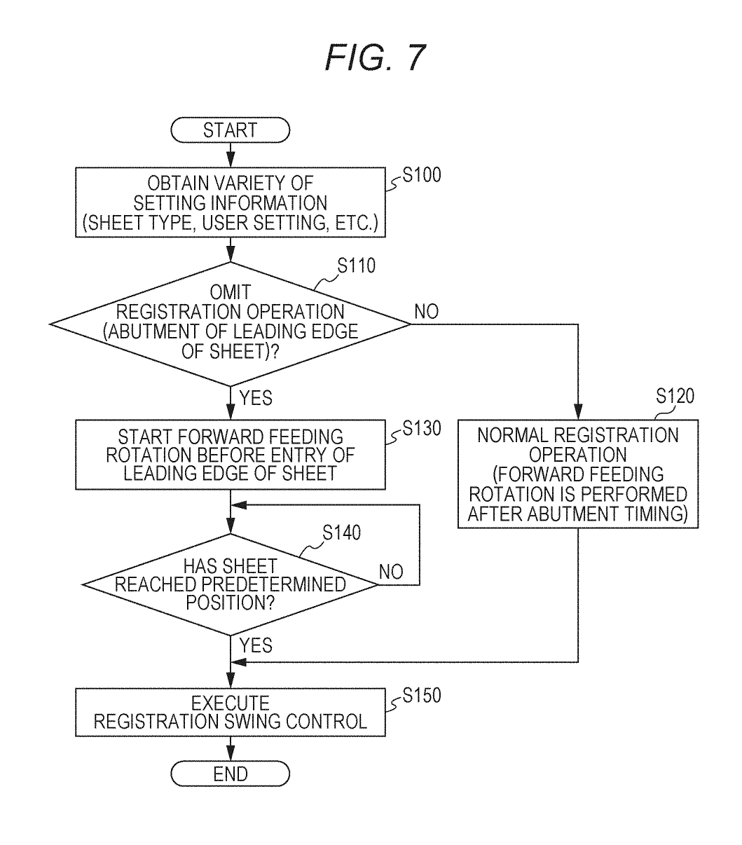

Hereinafter, an example of processing executed by the controller 100 regarding control of operation of the registration roller pair 53a in the image former 1 and sheet conveyance control will be described with reference to the flowchart of FIG. 7. This example is an assumed case where address etc. is to be printed on the above-described envelope E as the sheet S.

In execution of the print job, the controller 100 obtains a variety of setting information for the print job (step S100). Here, the setting information obtained by the controller 100 includes: for example, information related to the type of sheet S used for the printing (for example, the information that the sheet S is an envelope E, the size of the main body of the envelope E or the size of the flap E_{f}) and user setting defining orientation of the envelope E and presence or absence of double-sided printing.

In step S110, the controller 100 refers to the obtained setting information to determine whether to omit the above-described registration operation (abutment of the leading edge of the sheet S, etc.), that is, which of the second operation or the first operation is to be executed. In this example, in a case where the leading edge in the conveyance direction is on the lower side of the envelope E (refer to FIG. 3A), the first operation, that is, the normal registration operation is executed (step S110, NO). In contrast, in a case where the leading edge in the conveyance direction is on the upper side (refer to FIG. 3B) of the envelope E (flap E_{f} side), the registrationless operation (second operation) is executed (step S110, YES).

When determined to execute the first operation (NO in step S110), the controller 100 controls the driving source of the registration roller pair 53a so as to perform the normal registration operation (step S120) and proceeds to step S150. Under the control of step S120, the registration roller pair 53a continues to be in a state of rotation stop or reverse feeding rotation until abutment of the leading edge of the sheet S (in this example, the bottom side of the envelope E), and the registration roller pair 53a starts forward feeding operation when the bottom side of the envelope E is abutted against the registration roller pair 53a. As a result of this first operation, the skew of the envelope E is corrected by the registration roller pair 53a (refer to FIG. 5A and FIG. 5B) and the envelope E is conveyed to the secondary transfer nip.

In contrast, in a case where the controller 100 determines to execute (YES in step S110) the registrationless operation (second operation), the controller 100 controls the driving source of the registration roller pair 53a such that the forward feeding rotation is started before the leading edge of the sheet S (flap E_{f} side of the envelope E) reaches (enters) the registration roller pair 53a (step S130). With this control, the registration roller pair 53a conveys the envelope E as it is toward the secondary transfer nip without performing the abutment (temporarily stopping) operation on the leading edge (side of the flap E_{f} of the envelope E) of the sheet S. Accordingly, while skew would not be corrected at this point in a case where the envelope E is skewed, it is possible to reduce the conveyance time to the secondary transfer nip.

In step S140 following step S130, the controller 100 determines whether the sheet S (envelope E) has reached a predetermined position in the sheet conveyance direction. In this example, the controller 100 determines whether the flap E_{f} of the envelope E has passed through the registration roller pair 53a (refer to FIG. 4), that is, whether the main body portion of the envelope E has reached the registration nip. The controller 100 repeats the determination of step S140 while it determines that the main body portion of the envelope E has not reached the registration nip (step S140, NO). In a case where the controller 100 determines that the main body portion of the envelope E has reached the registration nip (step S140, YES), the processing proceeds to step S150.

In step S150, the controller 100 controls the rotation and swinging of the registration roller pair 53a so as to perform registration swing (alignment of the side edge of the sheet S) together with the operation of timing adjustment of the leading edge timing of the sheet S described above. The operation of registration swinging is represented in the present example by the operation performed by the controller 100 to swing the registration roller pair 53a the width direction to align the position of the side edge of the sheet S (envelope E) sensed by the line sensor 54 with the target position (refer to the dotted line on the lower side of FIG. 6A and FIG. 6B).

After the control of step S150, the controller 100 finishes the above-described series of processing. In step S150, the control of the registration swing can be continued even after the sheet S (envelope E) reaches the secondary transfer nip.

In execution of a double-sided printing job, the controller 100 returns to step S110 after step S150 and performs conveyance control for the second surface of the sheet S (envelope E). In this example, in a case where the normal registration operation (first operation) of step S120 is performed at the printing of the first surface of the envelope E, the registrationless operation (second operation) of step S130 is performed at the printing of the second surface. Conversely, in a case where the registrationless operation (second operation) of step S130 is performed at the printing of the first surface of the envelope E, the normal registration operation (first operation) of step S120 is performed at the printing of the second surface.

According to the image former 1 that performs the control as described above, it is possible to improve the positional accuracy of the transferred image with respect to the envelope E and a variety of sheets S.

The above description of the control of the registration swing is an exemplary case where the controller 100 specifies the direction and the amount of misalignment of the side edge of the sheet S using the line sensor 54 and starts the swing operation of the registration roller pair 53a. Alternatively, in a case where the direction or amount of the misalignment of the side edge of the sheet S are known beforehand (predictable) as a feature of the machine or the like, the controller 100 may start in step S150 swinging of the registration roller pair 53a without using the detection result obtained with the line sensor 54. In this case, the timing to start swinging of the registration roller pair 53a or the position (swinging point) on the sheet S (envelope E), the swing direction, and the amount of swing may be defined as fixed values (preset values). Accordingly, the controller 100 reads out each of values defined as preset values to a memory or the like prior to the start of the swinging in step S150 as setting values, and performs swinging control of the registration roller pair 53a according to the setting values.

The above-described embodiment is an exemplary case where the envelope E is used as the special sheet. Alternatively, the above embodiment can be similarly applied to special sheets other than the envelope E, as well as normal sheets such as regular sheets.

That is, in order to perfectly correct the skew of the sheet S, the side of the sheet S on the leading edge side in the conveyance direction need to be perfectly perpendicular (exactly) 90° to the side of the side edge of the sheet. On the other hand, due to differences in machines (such as cutting machines) at the time of manufacturing the sheet S, manufacturing tolerances, or the like, there are often sheets not having a perfect right angle as described above, even among regular sheets. According to the registrationless operation (second operation) of the present embodiment, it is possible to ensure the accuracy of the position of an image to be formed even on this type of sheet S since the leading edge of the sheet S is not abutted against the registration roller pair 53a. In sum, according to the registrationless operation (second operation) of the present embodiment, it is possible to ensure the accuracy of the position of an image to be formed and achieve image assurance regardless of the shape, angle, or the like, of the leading edge side of the sheet S in the conveyance direction.

The above-described embodiment is an example of an image former having a transferer for secondarily transferring an image to be printed onto the sheet S by using the intermediate transfer belt 421. Alternatively, the above-described embodiment can also be applied to an image former of a transfer system (for example, a monochrome printer, an ink jet printer, or the like) that primarily transfers an image to be printed onto the sheet.

Although embodiments of the present invention have been described and illustrated in detail, the disclosed embodiments are made for purposes of illustration and example only and not limitation. The scope of the present invention should be interpreted by terms of the appended claims. That is, the present invention can be implemented in various forms without departing from the spirit or the main features thereof.

What is claimed is:

1. An image former comprising:
a transferer that transfers an image onto a sheet;
a registration roller provided on an upstream side of the transferer in a sheet conveyance direction; and
a hardware processor that controls operation of the registration roller,
wherein the hardware processor controls operation of the registration roller so as to execute either one of first operation of abutting a leading edge of the sheet in the conveyance direction against the registration roller and second operation of not abutting the leading edge of the sheet against the registration roller.

2. The image former according to claim 1,
wherein the hardware processor controls to rotate the registration roller in the conveyance direction before entry of the leading edge of the sheet into the registration roller in the second operation.

3. The image former according to claim 1,
wherein the hardware processor determines operation of the registration roller with reference to preset information and executes one of the first operation and the second operation in accordance with a result of the determination.

4. The image former according to claim 1,
wherein the hardware processor controls swinging of the registration roller so as to allow the sheet to be swung along a width direction of the sheet in order to prevent misalignment of the sheet, after execution of one of the first operation and the second operation.

5. The image former according to claim 4,
wherein the hardware processor performs control of adjusting a rotation speed of the registration roller to be matched with a position at which the image is transferred by the transferer in the sheet conveyance direction, after execution of one of the first operation and the second operation.

6. The image former according to claim 5,
wherein the hardware processor starts the control of adjusting the rotation speed of the registration roller that follows the execution of the second operation at a timing after the sheet reaches a predetermined position in the sheet conveyance direction.

7. The image former according to claim 1,
wherein, in case of executing double-sided printing of the sheet, the hardware processor controls operation of the registration roller to execute one of the first operation and the second operation at printing of a first surface of the sheet and to execute the other of the first operation and the second operation at printing of a second surface of the sheet.

8. The image former according to claim 5,
wherein the hardware processor controls swinging of the registration roller so as to correct a target position of a side edge of the sheet being conveyed by the registration roller.

9. A conveyance control method for an image former including: a transferer that transfers an image onto a sheet; and a registration roller provided on an upstream side of the transferer in a sheet conveyance direction,
the method comprising executing either one of first operation of abutting a leading edge of the sheet in the conveyance direction against the registration roller and second operation of not abutting the leading edge of the sheet against the registration roller.
